(19) United States
(12) Patent Application Publication
(10) Pub. No.: US 2009/0055406 A1
(43) Pub. Date: Feb. 26, 2009

(54) Content Distribution System

(76) Inventors: Norimitsu Kubono, Tokyo (JP); Yoshiko Kage, Tokyo (JP)

Correspondence Address: DAY PITNEY LLP, 7 TIMES SQUARE, NEW YORK, NY, 10036-7311, US

(21) Appl. No.: 12/223,421

(22) PCT Filed: Feb. 5, 2007
(86) PCT No.: PCT/JP2007/051905

§ 371 Date: Jul. 31, 2008

(30) Foreign Application Priority Data
Feb. 7, 2006 (JP) 2006-029122

(51) Int. Cl. G06F 17/30

(52) U.S. Cl. 707/10; 707/E17.032

(57) ABSTRACT

In a content distribution system 100 including a Web server 40 and a terminal device 50, the Web server 40 includes a final content file 25 for managing a content, a meta content file 26 for describing and managing, in a meta content, at least information on the playback start time of the content, an annotation to be superimposed on the content, and display time information, and a content distribution function 41 which reads and the annotation and the display information of the annotation from the final content file 25 and the meta content file 26 together with the content to generate display information (for example data in a dynamic HTML format), and distributes the display information to the terminal device 50. The terminal device 50 includes a Web browser 51 for receiving the display information from the Web server 40 and displaying the display information.

### TECHNICAL FIELD

The present invention relates to a content distribution system which distributes synchronized multimedia contents including contents such as a moving picture and still images.

### BACKGROUND ART

Authoring tools are known for generating a synchronized multimedia content in which media having duration (time-based media) such as moving pictures and audio and media that does not have duration (non-time-based media) such as text information and still images are incorporated by editing (for example see Patent Document 1).

### Patent Document 1: National Publication of International Patent Application No. 2004-532497

However, such an authoring tool has problems that, because a synchronized multimedia content generated by the authoring tool has a data structure into which contents are edited and integrated as an integral structure, enablement and disablement of display of text and graphics information (annotations) superimposed on a moving picture or still images cannot be controlled and the portions of the moving picture and still images on which the annotations are superimposed are not visible, and that a user cannot flexibly add annotations to the content.

The present invention has been made in light of the problems and an object of the present invention is to provide a content distribution system that manages annotations superimposed on contents such as moving picture and still image contents independently of the contents and enables disablement and enablement of display of annotations and addition of annotations to contents.

### DISCLOSURE OF THE INVENTION

To solve the problems, a content distribution system according to the present invention includes a server device (for example Web server 40 in an embodiment) and a terminal device. The server device includes: distribution content managing means (for example a final content file 25 in an embodiment) for managing a content; meta content managing means (for example a meta content file 26 in an embodiment) for describing and managing at least playback start time information of the content, an annotation superimposed on the content, and display time information of the annotation in a meta content; and distributing means (for example a content distribution function 41 in an embodiment) for reading the annotation and the display time information of the annotation from the distribution content managing means and the meta content managing means together with the content to generate display information (for example data in a dynamic HTML format in an embodiment) and distributing the display information to the terminal device; and the terminal device comprising displaying means (for example a Web browser 51 in an embodiment) for receiving the display information from the server device and displaying the display information.

The displaying means in the content distribution system according to the present invention preferably allows selection between enablement and disablement of display of the annotation contained in the display information.

In the content distribution system according the present invention, preferably the distributing means includes annotation extracting means (for example an annotation merge function 42 in an embodiment) for extracting the annotation from the meta content managing means and distributing the annotation to the terminal device when the distributing means sends the display information to the terminal device; the terminal device includes table-of-contents means (for example a table-of-contents function 53 in an embodiment) for receiving the extracted annotation, displaying the annotation to allow the annotation to be selected, and sending the selected annotation to the server device; and the distributing means generates the display information played back from the display time information associated with the selected annotation and distributes the display information to the terminal device when the distributing means has received the annotation selected from the table-of-contents means.

The server device in the content distribution system according to the present invention preferably includes playback control means (for example a playback control function 43 in an embodiment) for seeking to a playback position in the content that corresponds to the display time information and distributing as the display information to be played back from the playback position when the content is moving picture information.

Preferably, the terminal device includes annotation adding means (for example an annotation adding function 52 in an embodiment) for adding an annotation and display time information of the annotation to the display information displayed on the displaying means and sending the added annotation and the display time information to the server device; the server device includes annotation managing means (for example an annotation management file 28 in an embodiment) for managing the added annotation and the display time information of the annotation and annotation registering means (for example an annotation registration function 44 in an embodiment) for registering the added annotation and the display time information sent from the annotation adding means in the annotation managing means; and the annotation extracting means extracts the annotation and the display time information of the annotation from the meta content managing means, retrieves the added annotation and the display time information of the added annotation from the annotation managing means, merges the annotation and the display time information extracted from the meta content managing means with the added annotation and the display time information retrieved from the annotation managing means, and distributes merged information to the terminal device.

When the added annotation and the display time information of the added annotation are registered in the annotation managing means by the annotation registering means, the distributing means preferably distributes the display information to the terminal device and distributes the annotation to the terminal device by the annotation extracting means.

Preferably, the added annotation and the display time information of the added annotation have identification information of a content user who added the annotation and the displaying means allows selection between enablement and disablement of display of the added annotation in accordance with the identification information.

In the content distribution system according to the present invention, the annotation is preferably composed of text information or a graphic.

### ADVANTAGES OF THE INVENTION

With the configuration of the content distribution system according to the present invention described above, annotations superimposed on contents such as moving picture and still image contents can be managed independently of the contents. Accordingly, disablement and enablement of display of the annotations can be controlled and annotations can be flexibly added to the contents. Therefore, the scope of application of synchronized multimedia contents can be expanded.

### BRIEF DESCRIPTION OF THE DRAWINGS

FIG. 1 is a block diagram showing a configuration of a content editing and generating system according to the present invention;

FIG. 2 is a diagram illustrating a user interface of an authoring function;

FIG. 3 is a block diagram showing a relationship among source content file, a view object, and a display object and a content clip;

FIG. 4 shows data structure diagrams of structures of view objects, in which part (a) shows a data structure of a content having duration and part (b) shows a data structure of a content that does not have duration;

FIG. 5 shows diagrams illustrating a relationship between a source content and view objects, in which part (a) shows a case where one source content is associated with one view object and part (b) shows a case where one source content is associated with two view objects;

FIG. 6 shows diagrams illustrating a relationship between positions of tracks in a timeline window and layers in a stage window, in which part (a) shows the relationship before transposition (b) shows the relationship after the transposition;

FIG. 7 is a data structure diagram showing a structure of a scope;

FIG. 8 shows diagrams illustrating a relationship between a source content and scopes, in which part (a) shows a case where first and second scopes are arranged in this order and part (b) shows a case where the scopes are transposed;

FIG. 9 is a diagram illustrating a pause clip;

FIG. 10 is a data structure diagram showing a structure of a pause object;

FIG. 11 shows diagrams illustrating how blocks are moved, wherein part (a) shows a state before the blocks are moved and part (b) shows a state after the blocks have been moved;

FIG. 12 is a block diagram illustrating specific functions of the authoring function;

FIG. 13 is a block diagram showing a configuration of a content distribution system;

FIG. 14 is a data structure diagram showing a structure of an annotation management file; and

FIG. 15 is a flowchart showing a process for generating a thumbnail file.

### DESCRIPTION OF SYMBOLS

25 Final content file (distribution content managing means)
26 Meta content file (meta content managing means)
28 Annotation management file (annotation managing means)
40 Web server (server device)
41 Content distribution function (distributing means)
42 Annotation merge function (annotation extracting means)
43 Playback control function (playback control means)
44 Annotation registration function
50 Terminal device
51 Web browser (displaying means)
52 Annotation adding function (annotation adding means)
53 Table-of-contents function (table-of-contents means)
100 Content distribution system

### BEST MODE FOR CARRYING OUT THE INVENTION

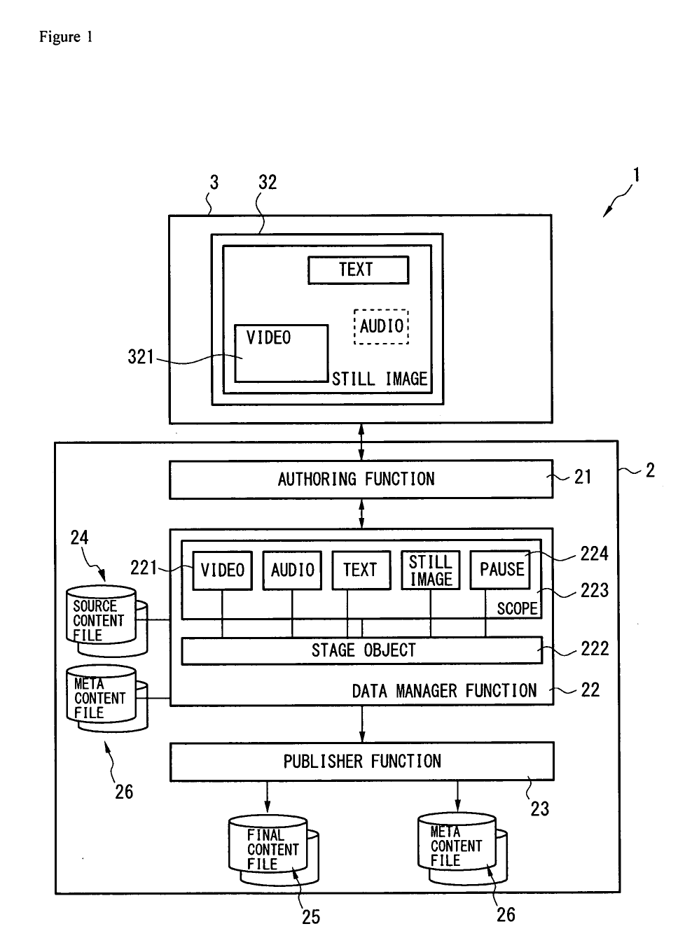

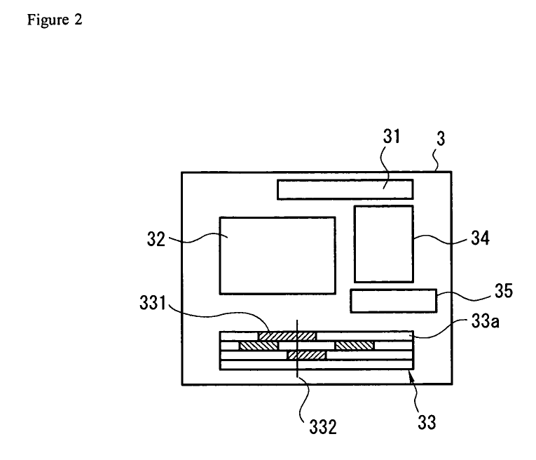

Preferred embodiments of the present invention will be described with reference to the drawings. A configuration of a content editing and generating system 1 according to the present invention will be described first with reference to FIGS. 1 and 2. The content editing and generating system 1 is executed on a computer 2 having a display unit 3 and includes an authoring function 21 for editing a synchronized multimedia content by using devices such as a mouse and a keyboard (not shown) connected to the computer 2 and using the display unit 3 as an interface, a data manager function 22 which manages information on the content being edited, and a publisher function 23 which generates the content thus edited (called “edited content”) as a final content that can be provided to users (namely a synchronized multimedia content as described above). Data (such as moving picture and still image files) from which a synchronized multimedia content is generated is stored beforehand as source content files 24 in a storage such as a hard disk of the computer 2.

A user interface displayed on the display unit 3 by the authoring function 21 includes a menu window 31, a stage window 32, a timeline window 33, a property window 34, and a scope window 35 as shown in FIG. 2. The menu window 31 is used by an editor for selecting an operation for editing and generating a content and provides control of operation of the entire content editing and generating system 1. The stage window 32 is a window on which the editor attaches a source content as a display object 321 as shown in FIG. 1 and moves, enlarges, reduces or otherwise manipulates the display object 321, thus allowing the editor to directly edit the content displayed as it will appear as an edited content when ultimately generated. The timeline window 33 includes multiple tracks 33a and is used for assigning content clips 331 of individual display objects 321 attached on the stage window 32 to tracks 33a for managing the content clips 331. The timeline window 33 is used to set and display execution time points of the display objects 321 (the display start time of an image or the playback start time of audio which are relative to the start time of the edited content assigned to the timeline window 33).

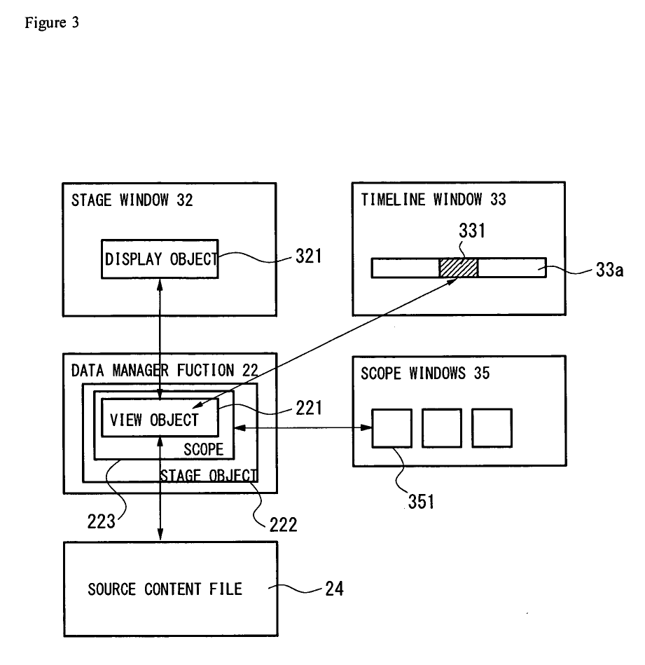

A method for managing data in the content editing and generating system 1 according to the exemplary embodiment will be described with reference to FIG. 3. Display objects 321 positioned on the stage window 32 in the content editing and generating system 1 are managed through view objects 221 generated in the data manager function 22, rather than being managed by directly editing source content files 24. That is, in the data manager function 22, a stage object 222 for managing information on the stage window 32 is generated for the stage window 32 and display objects 321 attached on the stage window 32 are managed as view objects 221 associated with the stage object 222. The content editing and generating system 1 associates and manages contents clips 331 assigned to tracks 33a of the timeline window 33 with the view objects 221. The content editing and generating system 1 also associates and manages display objects 321 positioned on the stage window 32 with a scope 223, which will be described later.

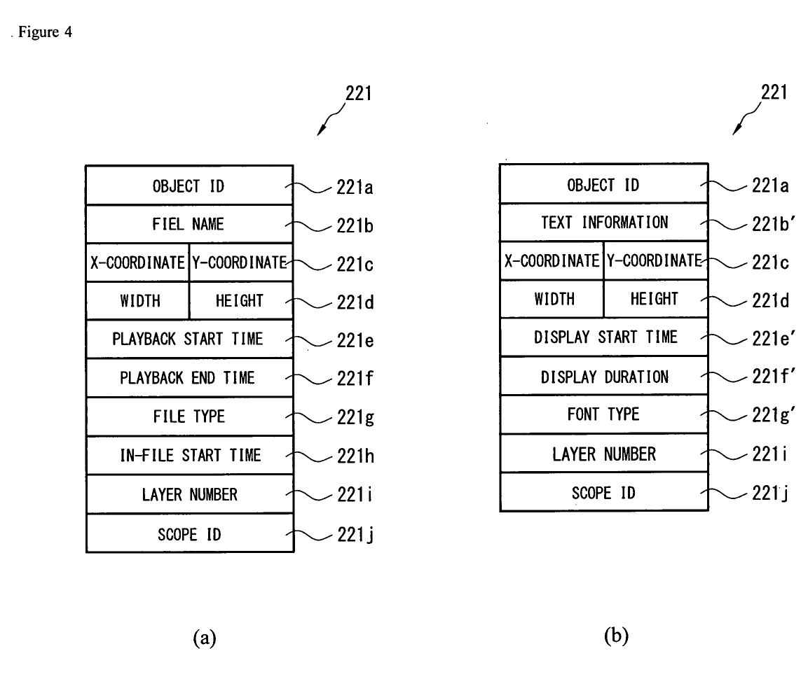

For example, if a display object 321 represents a moving picture file, a data structure of a view object 221 for managing the moving picture file includes, as shown in FIG. 4 (a), an object ID field 221a containing an object ID for identifying the view object 221, a filename field 221b containing a storage location (for example the file name) of a source content file 24, an XY coordinate field 221c containing relative XY coordinates of the display object 321 on the stage window 32 with respect to the stage window 32, a width/height field 221d containing a display size of the display object 321 on the stage window 32, a playback start time field 221e containing a relative playback start time of the display object 321 in an edited content (time point relative to the starting point of the edited content or the starting point of a scope, which will be described later), and playback end time field 221f containing playback end time, a file type field 221g containing the file type of the source content file 24, an in-file start time filed 221h containing a time point in the source content file 24 corresponding to the display object 24 at which playback of a moving picture is to be started (a time point relative to the start time of the source content file 24), a layer number field 221i containing a layer number, which will be described later, and an scope ID field 221j containing a scope ID indicating the scope 223 to which the view object 221 belongs.

In the content editing and generating system 1 according to the present exemplary embodiment, contents that have duration such as audio data and data that does not have duration such as text data, still image data, graphics can be treated as well as moving picture data. A content having duration has the same data structure as that of moving picture data described above (except that audio data does not have an XY coordinate field and a width/height filed); a content that does not have duration has a data structure similar to the data structure described above, excluding an in-file start time field 221h. For example, to manage text data, the text information is stored in a text information field 221b′ and information indicative of a font in which the text information is displayed is stored in a font type filed 221g′ as shown in FIG. 4 (b). The text information may be managed as a source content file 24. Instead of storing playback start and end times as with a moving picture content, a display start time field 221e′ and display duration field 221f′ may be provided for managing the display start time of the text information and the duration for which the text information is displayed. To manage graphics data as a view object 221, a graphic having a given shape is defined and registered beforehand as a source content file 24 and the graphic may be made selectable using identification information (such as a number) to display.

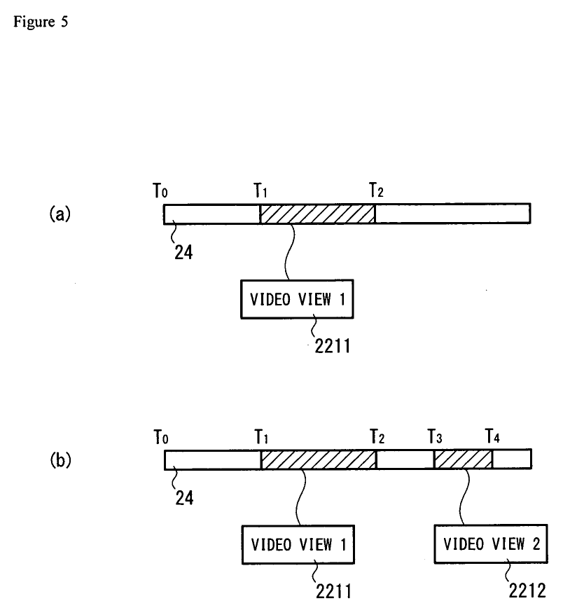

Because the data manager function 22 manages display objects 321 displayed on the stage window 32 using view objects 221 corresponding to source content files 24 as described above, one view object 2211 can be defined for time T1-T2 in one source content file 24 (especially for moving picture or audio contents) as shown in FIG. 5 (a) or two view objects 2211 and 2212 for time T1-T2 and time T3-T4 in one source content file 24 as shown in FIG. 5 (b). Because multiple view objects 221 can be defined using the same source content file 24 in this way, memory consumption of a memory and hard disk can be reduced as compared with a system that holds entities (copies of a source content file 24) for individual display objects 321. When multiple view objects 221 are defined, time points of the multiple view objects 221 may be defined in such a manner that they overlap in the source content file 24, of course (for example, time points in FIG. 5 (b) may be defined such that T3<T2).

Because a view object 221 of a time-based content (having duration) such as a moving picture has an in-file start time field 221h containing a time point at which playback of the content is to be started in the source content file 24, the source content file 24 does not need to be executed from time T0 (namely from the beginning) of the source content file 24 as shown in FIG. 5 (a) but an editor can flexibly set the time point at which playback is to be started for each view object 221. Furthermore, the editor can flexibly set and change the time points of view objects in a source content file 24 through the timeline window 33, for example, because the source content file 24 is not directly edited, as described above.

A content can be positioned in the stage window 32 by dragging and dropping the source content file 24 by using a mouse or by selecting the source content file 24 from the menu window 31. Text information and graphics also can be positioned by displaying predetermined candidates in a popup window and dragging and dropping any of the candidates from the popup window to the stage window 32. When a content (display object 321) is positioned in the stage window 32, a content clip 331 associated with the display object 321 is placed on the currently selected track 33a in the timeline window 33. In the timeline window 33, a current cursor 332 indicating a relative time in the synchronized multimedia content (edited content) being edited is displayed as shown in FIG. 2. The content clip 331 is automatically positioned on a track 33a so that playback of the display object 321 starts at the time point indicated by the current cursor 332. The duration of the entire source content file 24 is displayed as an outline bar, for example, on the track 33a and a playback segment (which is determined by the in-file start time field 221h, the playback start time field 221e, and the playback end time field 221f) defined in the view object 221 is displayed as a color bar (which corresponds to the content clip 331).

There is no limitation on the types of contents placed on multiple tracks 33a provided in the timeline window 33. Any types of contents can be placed such as a moving picture content, an audio content, a text information content, a graphics content, a still image content, and an interactive content that requests an input. Icons (not shown) representing the types of the contents positioned are displayed on the tracks 33a, which allow the contents positioned to be readily identified. Accordingly, the editor can efficiently edit the contents.

When multiple display objects 321 are placed on the stage window 32, some of the display objects 321 overlap with each other. The multiple display objects 321 in the stage window 32 are placed in any of stacked transparent layers and managed. Each display object 321 is managed with a layer number assigned to the display object 321 (in the layer number field 221i shown in FIG. 4). The order in which the layers are stacked corresponds to the order in which the tracks 33a are positioned. That is, the order in which overlapping display objects 321 are displayed (order of layers) is determined by the places of tracks 33a on which content clips 331 corresponding to the display objects 321 are positioned (assigned).

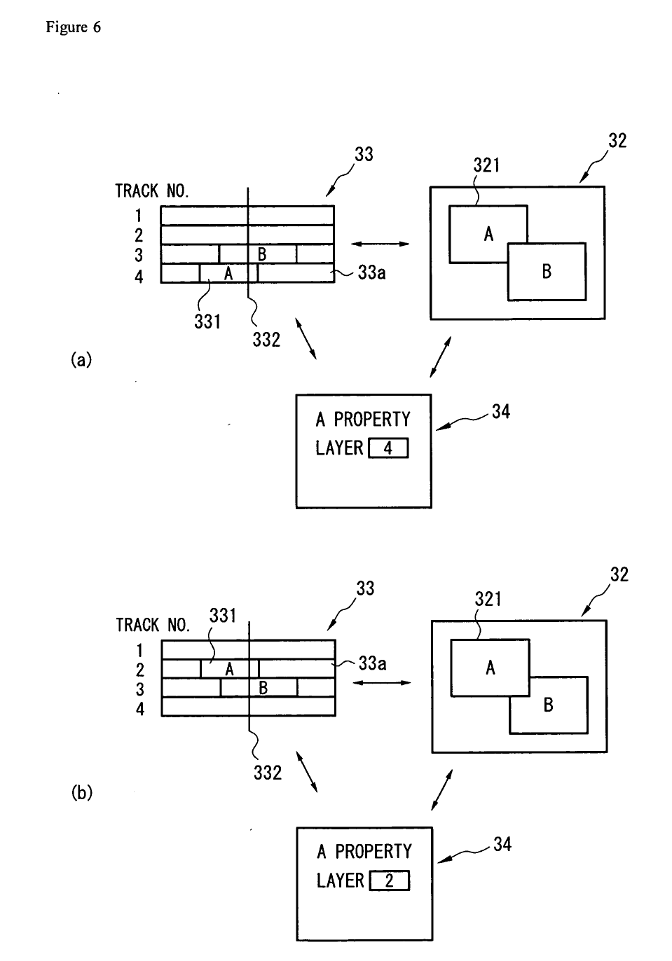

For example, two display objects 321 A and B are positioned in the stage window 32, a content clip 331 corresponding to display object A is positioned on track 4 in the timeline window 33 (layer 4 in the stage window 32), and a content clip 331 corresponding to display object B is positioned on track 3 (layer 3) in the timeline window 33 as shown in FIG. 6 (a). When the content clip 331 corresponding to display object A is moved to track 2 in the timeline window 33, the authoring function 21 positions the display objects 321 in the layers in the stage window 32 in the order of the tracks 33a on which the corresponding content clips 331 are placed. That is, the display objects 321 are overlapped in the order in which the tracks 33a are stacked in such a manner that display object A appears on top of display object B as shown in FIG. 6 (b). Therefore, the editor can perform edits intuitively and the efficiency of editing is improved.

Furthermore, the editor can flexibly change the size and position of a display object 321 on the stage window 32 with a device such as a mouse. Similarly, the editor can flexibly change the position and size (playback duration) of a content clip 331 on the timeline window 33 and the playback start position in a source content file 24 with a device such as a mouse. When the editor positions a source content file 24 on the stage window 32 and moves or resizes a source content file 24 on the stage window 32 or changes the position or playback period of a content clip 331 on the timeline window 33, the authoring function 21 sets the display object 321 and the properties of the view object 221 corresponding to the content clip 331 in accordance with the change made by the editor's operation on the stage window 32 and the timeline window 33. The properties of the view object 221 can be displayed and modified from the property window 34.

The synchronized multimedia content thus edited by using authoring function 21 (edited content) has given start and end times (relative time points). In the content editing and generating system 1, the time period defined by these time points can be divided into scopes 223 and managed. A content having duration, such as a moving picture, has a time axis, and therefore has an inherent problem that when an edit (such as move or delete) is performed at a time point, the edit has a side effect on other sections of the moving picture. Therefore, in addition to physical information (placement of the content on the timeline window 33), multiple logically defined (virtual) segments called scopes 223 are provided for a moving picture content having a time axis to allow a content to be divided in the present exemplary embodiment.

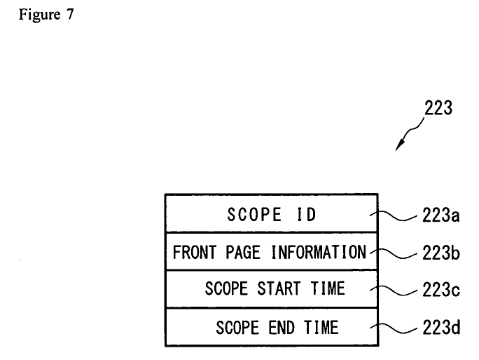

As shown in FIG. 7, a data structure of a scope 223 includes a scope ID field 223a containing a scope ID for identifying the scope among the multiple scopes, a display information field 223b containing information on a front page displayed on the stage window 32 when the scope 223 is started, a scope start time field 223c containing a relative start time of the scope 223 in the edited content, and a scope end time field 223d containing a relative end time in the edited content. The information on the front page includes text information, for example, and is used for listing the content of the scope 223 at the start of playback of the scope 223.

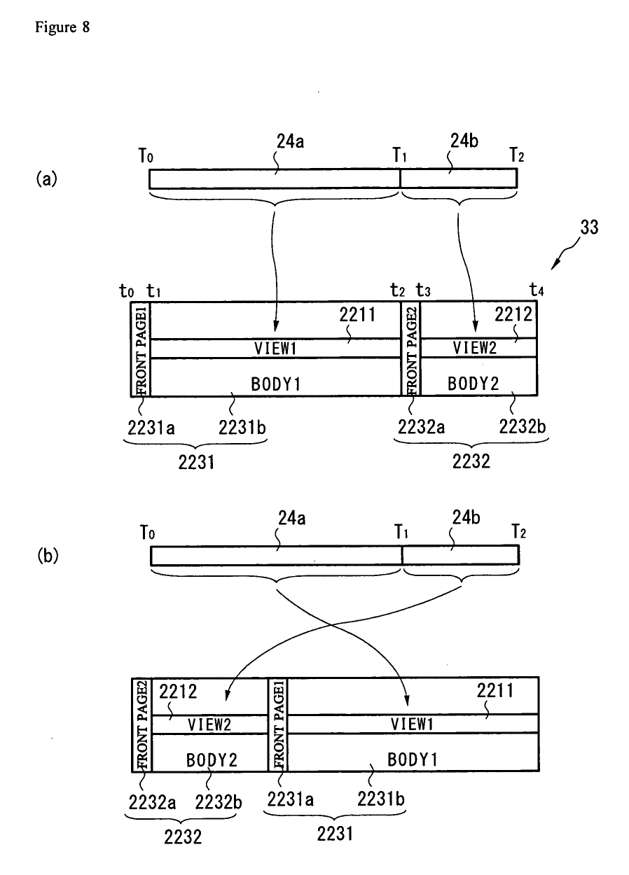

FIG. 8 shows the playback duration of an edited content divided into two scopes 2231 and 2232 represented in a track 33a in the timeline window 33. Each of the scopes 2231 and 2232 includes a front page 2231a, 2232a which lists the content of the scope for a predetermined period of time and a body 2231b, 2232b in which the content is placed. In the example shown in FIG. 8 (a), a first front page 2231a and a first body 2231b are defined for the first scope 2231; a second front page 2232a and a second body 2232b are defined for the second scope 2232. A section 24a corresponding to time T0-T1 in the source content file 24 is set as a first view object 2211 in the first body 2231b; a section 24b corresponding to time T1-T2 in the source content file 24 is set as a second view object 2212 in the second body 2232b. Accordingly, the first front page 2231a is displayed between time points t0 and t1 in the edited content, the second front page 2232a is displayed between time points t2 and t3, and the second body 2232b is displayed between time points t3 and t4.

In the data manager function 22, view objects 221 are managed on a scope-by-scope 223 basis as shown in FIG. 1 and therefore an operation on a particular scope 223 on the timeline window 33 does not affect data in the other scopes 223. For example, an operation for moving the second scope 2232 to before the first scope 2231 as shown in FIG. 8 (b) only changes the order of the scopes 2231, 2232 and does not affect the order and execution times of the view objects 2211, 2212 in the scopes 2231, 2232 (for example, the relative times of the view objects 2211, 2212 in the scopes 2231, 2232 do not change). Because the content editing and generating system 1 manages the source content file 24 through view objects 221 as described earlier, rather than directly editing the source content file 24, the change of the order in which the view objects 221 are executed does not affect the original source content file 24.

As shown in FIG. 3, scopes 223 can be displayed on the scope window 35 as scope lists 351 in chronological order. Each scope list 351 displays front page information described above, for example.

The provision of scopes 223 allows the playback order of a moving picture content in an edited content to be dynamically changed by specifying the order in which the scopes 223 are displayed without changing physical information (that is, without any operations such as cutting and repositioning the moving picture content). Furthermore, the effect of an edit operation in a scope 223 (for example a move of all elements that contain a moving picture content along the time axis or deletion) is limited to that local scope 223 and has no side effect on the other scopes 223. Therefore, the editor can perform edits without concern for the other scopes 223.

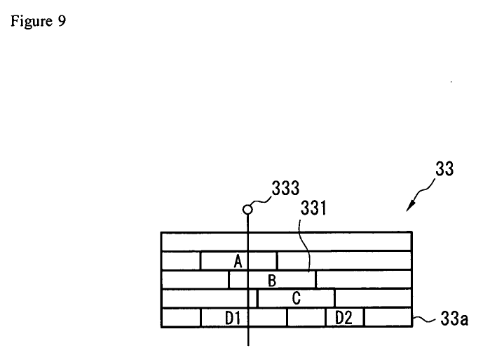

In the content editing and generating system 1, a special content clip called pause clip 333 can be positioned on a track 33a in the timeline window 33 as shown in FIG. 9. The pause clip 333 is managed as a pause object 224 in the data manager function 22 as shown in FIG. 1. For example, when the editor wants to stop playback of a content such as a moving picture content and to play back only narration (an audio content), the editor specifies the time point at which the pause is to be made on the timeline window 33 to position a pause clip 333. When the pause clip 333 is positioned, a property window 34 (shown in FIG. 2) corresponding to the pause clip 333 (pause object 224) is displayed on the display unit 3. The editor specifies (inputs) a source content file 24 executed in association with the pause clip 333 and a pause duration (duration for which playback of the content clip 331 (display object 221) positioned at the position in time at which the pause clip 333 is positioned is stopped and the source content file 24 associated with the pose clip 333 is played back). Then, the pause object 224 is generated in the data manager function 22.

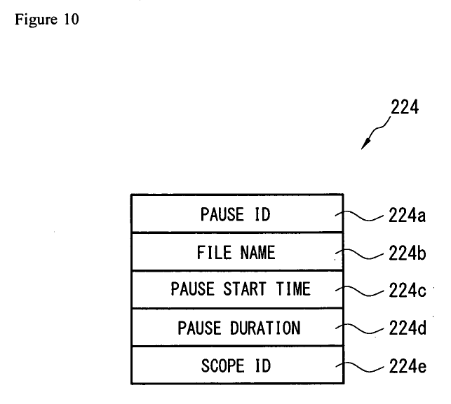

If an audio content is selected, a data structure of the pause object 224 includes a pause ID field 224a containing a pause ID for identifying the pause object 224, a filename field 224b containing the storage location of the source content file 24 corresponding to an object the playback of which is not to be stopped, a pause start time field 224c containing a pause start time in a scope 223, a pause duration field 224d containing a pause duration, and a scope ID field 224e containing the scope ID of the scope 223 to which the pause object 224 belongs, as shown in FIG. 10. If a moving picture content is specified with the pause object 224, property information such as XY coordinates of the moving picture content can be included.

By using the pause object 224 (pause clip 333), an operation can be implemented in which playback of a moving picture, for example, is paused and audio narration during the pause is played back during the pause, and then playback of the display object 321 of the moving picture is resumed. The operation will be described with respect to the example in FIG. 9. Playback of display objects A, B, and D1 (content clips 331 denoted by A, B, and D1) is stopped at the point at which the pause clip 333 is set with the display image at the point being maintained, and a source content file 24 associated with the pause object 224 is executed instead. Upon completion of the execution of the source content file 24 associated with the pause object 224, playback of the display objects A, B, and D1 is resumed from the point at which the playback of display objects A, B, and D1 were paused. That is, the pause object 224 (pause clip 333) allows a content (source content file 24) that is asynchronously executed to be set in a synchronized multimedia content.

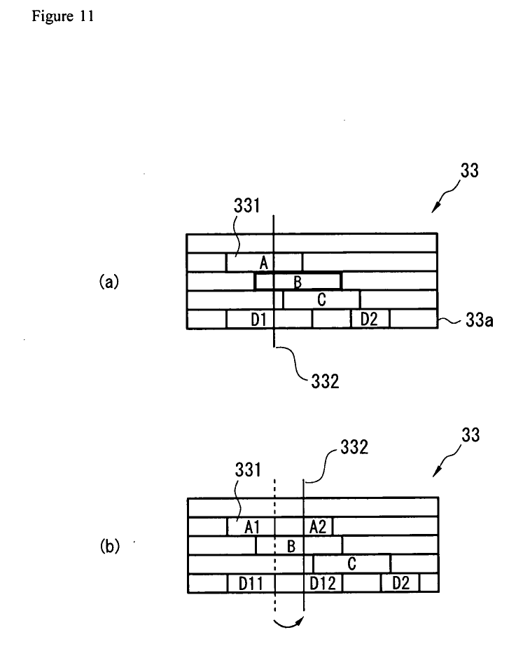

The authoring function 21 includes a content edit function that moves a group. The group moving function also allows a given display object 321 (associated with a content clip 331 positioned on a track 33a through the data manager function 22 as shown in FIG. 3) alone to be played back and the other display objects 321 to pause. In particular, as shown in FIG. 11 (a), the editor selects a layer (track) that is not to be paused with a mouse or the like (display object B (content clip 331 defined by B) is selected as the object not to be paused in FIG. 11 (a)). Then, the editor specifies a time point at which the pause is to be made on the timeline window 33 to position the current cursor 332. As the current cursor 332 is moved to a position at which playback is to be resumed as shown in FIG. 11 (b), the other contents clips (A, C, D1, and D2) are moved with the relationship among relative time points of the content clips (except content clip B) being maintained. The contents (A and D1) located at the pause time point (on the current cursor 332) are divided at the pause time point (content A is divided into sections A1 and A2 and D1 is divided into D11 and D12 as shown in FIG. 11 (b)) and the sections (A2 and D12) after the current cursor 332 are moved.

Also, a configuration is possible in which, instead of associating a pause clip 333 with a source content file 24 as described with reference to FIG. 9, an editor is allowed to select any of display objects (content clips 331) positioned on tracks 33a that is not to be paused to associate the display object with a pause clip (corresponding to the pause clip 333 in FIG. 9) as described with reference to FIG. 11. In that case, the editor selects a layer (track) not to be paused on the timeline window 33 by using a mouse or the like (for example, the editor selects display object B (content clip B) as the object not to be paused, as described with reference to FIG. 11). Then, the editor specifies the time point at which the pause is made on the timeline window 33 to position the pause clip 333. When the pause clip 333 is positioned, a property window 34 (shown in FIG. 2) associated with the pause clip 333 (pause object 224) is displayed on the display unit 3. When the editor specifies (inputs) a pause duration (time period in which playback of the objects not specified by the pause clip 333 are paused), a pause object 224 is generated in the data manager function 22. In this case, upon generation of the pause object 224, the other content clips 331 may be automatically shifted back by the amount equivalent to the pause duration as described with reference to FIG. 11. In the configuration in which a pause clip 333 is associated with a content clip 331 on a track 33a in this way, an editor may be allowed to select a track (content clip 331) to be paused by the pause clip 333 and associate the track (content clip 331) with the pause clip 333, instead of selecting and associating the track (content clip 331) not to be paused by the pause clip 333 as described above.

In this way, the authoring function 21 allows the editor to directly position a content on the stage window 32 and to change the position and size of the content. Accordingly, the editor can perform edits while checking the edited content being actually generated. Edits of display objects 321 on the stage window 32 can be performed as follows. One display object 321 may be selected at a time to make a change or multiple display objects may be selected at a time (for example by clicking a mouse on the display objects 321 while pressing a shift key or by dragging the mouse to determine an area to select all the display objects 321 in the area). The same operations can be performed on the timeline window as well. Also, a time segment on a track 33a can be specified with a mouse and a content clip 331 in the time segment can be deleted and all the subsequent content clips 331 can be moved up.

Because all display objects 321 positioned on the stage window 32 are managed as view objects 221 in the data manager function 22, a list of candidates among the view objects 221 that can be positioned as text objects may be displayed on the display unit 3 so that the editor can select a display object 321 on the list and position it as a new display object 321.

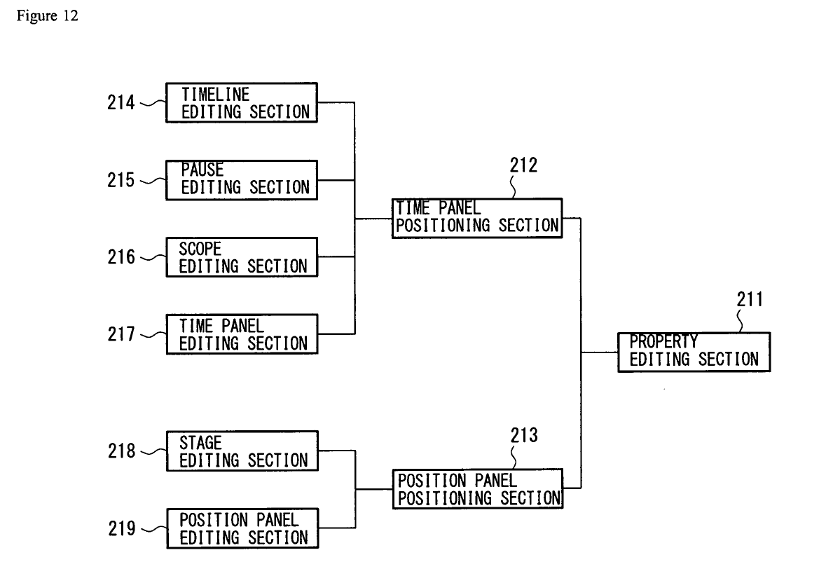

The configuration of the specific functions of the authoring function 21 described above will be summarized with reference to FIG. 12. The authoring function 21 includes a property editing section 211, which includes a time panel positioning section 212 and a position panel positioning section 213. The property editing section 211 provides the function of displaying a property window 34 to allow an editor to change a property of a view object 221.

The time panel positioning section 212 provides the functions of positioning and deleting a content clip 331 on a track 33a, changing a layer, and changing the start position of a content clip 331 on the timeline window 33. The time panel positioning section 212 includes a timeline editing section 214, a pause editing section 215, a scope editing section 216, and a time panel editing section 217. The timeline editing section 214 provides the function of performing edits such as adding, deleting, and moving a layer and the functions of displaying/hiding and grouping layers. The pause editing section 215 provides the functions of specifying a pause duration and time point and specifying a layer (content clip 331) not to be paused. The scope editing section 216 provides the functions of specifying the start and end of a scope 223 and moving a scope 223. The time panel editing section 217 provides the functions of changing playback start and end times of a content clip 331 positioned on a track 33a on the timeline window 33 and the pause, division, and copy functions described above.

The position panel positioning section 213 provides the function of specifying a position on the stage window 32 where the display object 321 is to be placed or an animation position. The position panel positioning section 213 also includes a stage editing section 218 and a position panel editing section 219. The stage editing section 218 provides the function of specifying the size of a display screen and the position panel editing section 219 provides the function of changing the height/width of the display screen.

The following is a description of a publisher function 23 that formats an edited content generated as described above into a final data format to be presented to users. The publisher function 23 generates a final content file 25 and a meta content file 26 to be ultimately provided to users from stage objects 222, view objects 221, scopes 223, and pause objects 224, and source content files 24 managed in the data manager function 22.

The final content file 25 is basically equivalent to a source content file 24 and is a file resulting from trimming unnecessary portions (for example portions that are not played back in a synchronized multimedia content ultimately generated) from the source content file 24 or changing the compression ratios of objects according to the size of the objects positioned on the stage window 32, as shown in FIG. 5 (b), for example. The meta content file 26 defines information for controlling, in an edited content, playback of a source content file 24 and a final content file 25 of a moving picture, audio, and still images, such as timing (time points) of execution (start of playback) and end of playback of the final content file 25, and a display image or display timing (time points) of information such as text information and graphics superimposed on the source content file 24 and the final content file 25. The meta content file 26 is managed as text-format data, for example. The meta content file 26 is also managed in the data manager function 22 as a file that manages information concerning the edited content edited by the authoring function 21, as shown in FIG. 1.

In this way, a synchronized multimedia content (edited content) is edited and generated in two stages, namely the authoring function 21 and the publisher function 23, in the content editing and generating system 1 according to the present exemplary embodiment. Therefore, during editing, information about display of a moving picture (start and end points) is managed in view objects 221 and information is held as logical views in such a manner that trimmed segments are not displayed. Accordingly, the start and end time points of the display can be flexibly changed. During generation, on the other hand, the source content file 24 is physically divided on the basis of logical view information (view objects 221). Consequently, the need for holding extra data is eliminated and the size of the final content file 25 can be reduced.

Furthermore, the final content file 25 generated from each source content file 24 by the publisher function 23 does not incorporate text information or the like (for example, text information is managed in the meta content file 26). This prevents the source content file 24 (or the final content file 25) from being changed with such text information (for example, incorporation of text information into a source content file such as a moving picture to generate a new source content file is avoided). Accordingly, compression of the source content file 24 does not result in blurred text or the like (blurred and unreadable text displayed on the screen).

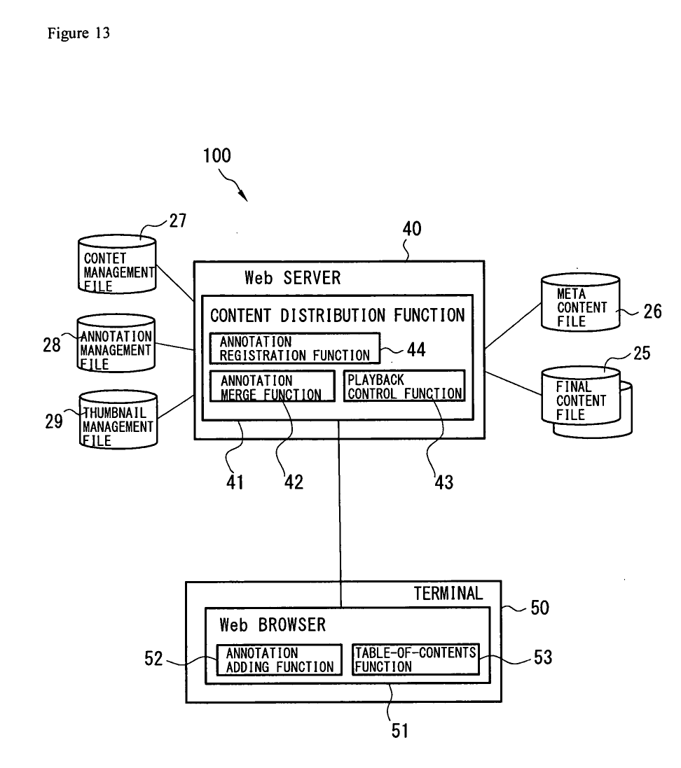

A content distribution system 100 for distributing an edited content thus generated using a final content file 25 and a meta content file 26 to users will be described next with reference to FIG. 13. While an edited content can be edited into a format (HTML format) that can be displayed on Web browsers and provided in the form of a CD-ROM, for example, a case will be described here in which a Web server 40 is used to provide an edited content to a Web browser 51 on a terminal device 50 connected through a network. The Web server 40 has final content files 25 and meta content files 26 generated by the publisher function 23 described above and a content management file 27 for managing the edited contents, an annotation management file 28 for managing annotations added by a user from the terminal device 50, and a thumbnail management file 29 for managing thumbnails of the edited contents.

The Web server 40 includes a content distribution function 41 and a user who wants to access from the terminal device 50 sends a user ID and a password, for example, to access the content distribution function 41. Then the content distribution function 41 sends a list of edited contents managed in the content management file 27 to the terminal device 50 to allow the user to select from the list. The content distribution function 41 reads a final content file 25 and a meta content file 26 corresponding to the selected edited content, converts the final content file 25 and the meta content file 26 to data in a dynamic HTML (DHTML) format, for example, and sends the converted files to allow them to be executed in the Web browser 51.

The meta content file 26 contains the type of media and media playback information (such as information about layers, the coordinates of display positions on the stage window 32, start and endpoints on the timeline) in a meta content format. Therefore, the Web browser 51 can dynamically generate an HTML file from a DHTML file converted from the meta content format and dynamically superimpose contents such as a moving picture and text information. The conversion function included in the content distribution function 41 is also included in the authoring function 21 described above. Text information and graphics are managed as the meta content file 26 separately from the final content file 25 including a content file such as a moving picture file as stated above and are superimposed on the final content file 25 when the final content file 25 is displayed in the Web browser 51. Accordingly, display of the text information and graphics on the Web browser 51 can be disabled (for example, display of the text information and graphics on the Web browser 51 can be disabled by using a script contained in the DHTML file) to display the portions (of a moving picture or a still image) on which the text information and graphics are superimposed.

Since the text information and graphics managed in the meta content file 26 have relative time points at which the text information and graphics are displayed in the edited content, the text information and graphics can be used as a table of contents of the edited content. In the content distribution system 100 according to the present exemplary embodiment, such text information and graphics are called “annotations” and a list of the annotations is presented on a terminal device 50 through a Web browser 51 to users. In particular, when the content distribution function 41 sends an edited content to a Web browser 51 on a terminal device 50, an annotation merge function 42 extracts text information and graphics contained in the meta content file 26 as annotations to generate table-of-contents-information including display start times and descriptions of the content and sends the table-of-contents information together with the edited content. A table-of-contents function 53 (defined as a script, for example) downloaded and running on the Web browser 51 receives the table-of-contents information and displays a pop-up window, for example, to display the table-of-contents information as a list.

According to the present exemplary embodiment, a final content file 25 can be played back on the terminal device 50 by specifying any of the time points in the finial content file 25, as will be described later. Therefore, playback of the edited content can be started at any of the display start times of annotations selected from the table-of-contents information listed by the table-of-contents function 53. The content distribution system 100 allows users to flexibly add annotations at terminal devices 50. Added annotations are stored in the annotation management file 28. The annotation merge function 42 merges annotations extracted from the meta content file 26 with added annotations managed in the annotation management file 28 to generate table-of-contents information and sends it to the table-of-contents function 53 of the Web browser 51.

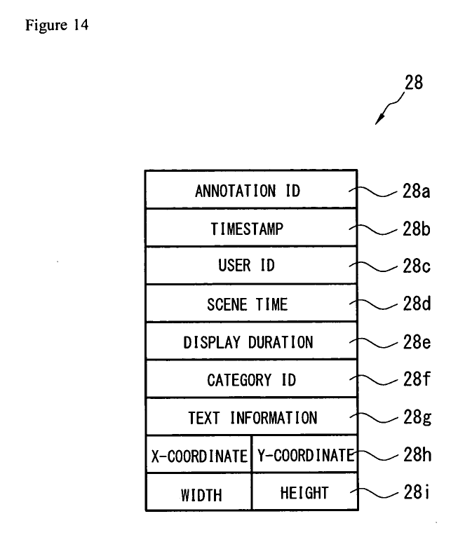

A data structure of the annotation management file 28 includes, as shown in FIG. 14, an annotation ID field 28a containing an annotation ID for identifying each annotation, a timestamp field 28b containing the time point at which the annotation was registered, a user ID field 28c containing a user ID of the user who registered the annotation, a scene time field 28d containing a relative time point at which the annotation is displayed in the edited content, a display duration field 28e indicating the duration for which the content is displayed, a category ID field 28f containing a category, which will be described later, a text information field 28g containing text information if the annotation is text information, an XY coordinate field 28h containing relative XY coordinates of the annotation on the edited content, and a width/height field 28i containing a display size of the annotation. If an annotation is a graphic, a field for containing identification information identifying the graphic is provided instead of the text information field 28g. The table-of-contents information generated by the annotation merge function 42 has the same data structure as the annotation management file 28.

To add an annotation, a user stops playback of an edited content on the terminal device 50 at the time point at which the user wants to add the annotation. Then, the user activates an annotation adding function 52 (defined as a script, for example) downloaded in the Web browser 51, specifies a position at which the user wants to insert the annotation on the screen, and inputs text information to add or the identification information of a graphic to add. The annotation adding function 52 sends the XY coordinates and display size of the text information or the graphic and the text information or the identification information of the graphic to the Web server 40 along with information such as the user ID of the user and the current time, which are in turn registered in the annotation management file 28 by an annotation registration function 44. Finally, the edited content and the table-of-contents information (including the added annotations) are reloaded from the Web server 40 to the Web browser 51 and the added annotations are reflected in the edited content. When annotations are added to the edited content, the category of the annotations can be selected (from among predetermined categories by identification information) so that display of the added annotation can be enabled or disabled by category. This can increase the usage value of the content. The category of the annotation is stored in the category ID field 28f in the annotation management file 28.

The table-of-contents function 53 displays the table-of-contents information on the terminal device 50 to allow the user to jump from the list to a desired position (time point at which a selected annotation of text information or a graphic is displayed) in the edited content to start playback from the position. Thus, the user can search the annotation list for a desired segment of the content, which enhances the convenience for the user. Added annotations registered in the annotation management file 28 can be displayed by other users as well as the user who registered them. Because the user ID of the user who registered annotations is stored along with the annotations, information indicating the user who added the annotations can be displayed or the annotations registered by the user can be extracted and displayed by specifying the user ID of the user. This can increase the information value of the content.

As has been descried, in the content distribution system 100 according to the present exemplary embodiment, playback of a final content file 25 on the terminal device 50 can be started by specifying any of the time points in the final content file 25. Control of playback of the content will be described below. When an item of table-of-contents information listed by the table-of-contents function 53 is selected, the URL of the edited content currently being presented and the annotation IDs of the annotation corresponding to the selected item of table-of-contents information (these items of information are integrated in the URL and sent in the present exemplary embodiment) is sent to a playback control function 43 of the Web server 40. The playback control function 43 extracts the annotation ID from the URL and identifies the scene time of the annotation. The playback control function 43 seeks to the identified scene time and generates a screen image (for example a DHTML code) at the scene time. The content distribution function 41 sends the screen image to the Web browser 51 and the Web browser 51 displays the screen image on the terminal device 50.

Since an edited content, in particular a final content file 25, is configured in such a manner that it can be played back from any position (time point) as described above, table-of-contents information using annotations can be combined with the edited content to allow a user to quickly search for any position in the edited content to play back. Thus, the information value of the content can be improved.

Thumbnails of the edited content at the display start times of annotations can be displayed in addition to the table-of-contents information using annotations described above to allow the user to more quickly find a position (time point) the user wants to play back, thereby improving the search performance and convenience for the user. The term thumbnail as used here refers to an image (snapshot) extracted from a display image of an edited content at a given time point. In the present exemplary embodiment, a thumbnail image at the time point at which each of the annotations described above is displayed is generated from the final content file 25 and the meta content file 26 and the thumbnail images generated are presented to the user as a thumbnail file in an RSS (RDF Site Summary) format.

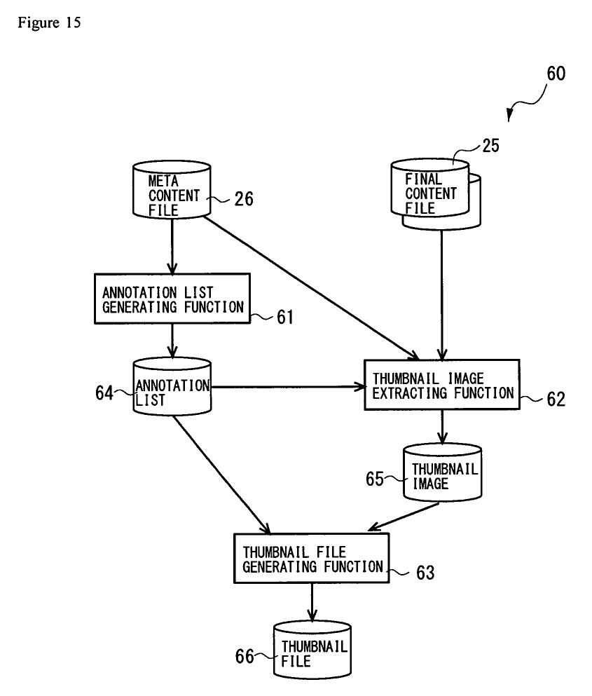

A method for generating a thumbnail file will be described first with reference to FIG. 15. The Thumbnail file is generated by a summary information generating function 60 executed on a computer 2 on which the content editing and generating system 1 is implemented and includes an annotation list generating function 61, a thumbnail image extracting function 62, and a thumbnail file generating function 63. When the summary information generating function 60 is initiated, the annotation list generating function 61 is activated first. The annotation list generating function 61 extracts text information or graphics from a meta content file 26 as annotations and outputs a set of relative time points (scene times) within the edited content at which the display of the annotations is started and the text information or the identification information of the graphics as an annotation list 64. Then, the thumbnail image extracting function 62 is activated and generates thumbnail images 65 of the edited content at the scene times for individual annotations extracted to the annotation list 64, from the final content file 25 and the meta content file 26. The thumbnail images 65 are generated as an image file in a bitmap or JPEG format and include small images to be listed and large images to be displayed as an enlarged image. Then, the thumbnail file generating function 63 is activated and generates a thumbnail file 66 in the RSS format from the annotation list 64 and thumbnail images 65 thus generated.

The annotation list generating function 61 can be configured to read annotations from the annotation management file 28 as well in which annotations added by users are stored, in addition to annotations in the meta content file 26, to generate an annotation list 64 into which the annotations are merged. The thumbnail images 65 are stored on the Web server 40 described above as a thumbnail management file 29. The URLs of the thumbnail images 65 are stored in the thumbnail file 66.

Since thumbnail images 65 of an edited content can be generated in association with annotations as a thumbnail file in the RSS format as described above, the user can list the thumbnail images 65 by using a function of an RSS viewer or a Web browser 51. Thus, the use of the edited content can be facilitated. Furthermore, annotations added by a user can be generated as a thumbnail file 66 in the RSS format at predetermined time intervals and distributed to other users to provide up-to-date information on the edited content to the users, for example. of course, an RSS-format file can be generated from annotation information (scene times and text information or identification information of graphics) alone without generating thumbnail images 65.

### INDUSTRIAL APPLICABILITY

Annotations superimposed on contents such as moving picture and still image contents can be managed independently of the contents. Accordingly, disablement and enablement of display of the annotations can be controlled and annotations can be flexibly added to the contents. Therefore, the scope of application of synchronized multimedia contents can be expanded.

1. A content distribution system comprising a server device and a terminal device, the server device comprising:
distribution content managing means for managing a content;
meta content managing means for describing and managing at least playback start time information of the content, an annotation superimposed on the content, and display time information of the annotation in a meta content; and
distributing means for reading the annotation and the display time information of the annotation from the distribution content managing means and the meta content managing means together with the content to generate display information and distributing the display information to the terminal device; and
the terminal device comprising displaying means for receiving the display information from the server device and displaying the display information.

2. The content distribution system according to claim 1, wherein the displaying means allows selection between enablement and disablement of display of the annotation contained in the display information.

3. The content distribution system according to claim 1 or 2, wherein:
the distributing means comprises annotation extracting means for extracting the annotation from the meta content managing means and distributing the annotation to the terminal device when the distributing means sends the display information to the terminal device;
the terminal device comprises table-of-contents means for receiving the extracted annotation, displaying the annotation to allow the annotation to be selected, and sending the selected annotation to the server device; and
the distributing means generates the display information played back from the display time information associated with the selected annotation and distributes the display information to the terminal device when the distributing means have received the annotation selected from the table-of-contents means.

4. The content distribution system according to claim 3, wherein the server device comprises playback control means for seeking to a playback position in the content that corresponds to the display time information and distributing as the display information to be played back from the playback position when the content is moving picture information.

5. The content distribution system according to claim 3, wherein:
the terminal device comprises annotation adding means for adding an annotation and display time information of the annotation to the display information displayed on the displaying means and sending the added annotation and the display time information to the server device;
the server device comprises annotation managing means for managing the added annotation and the display time information of the annotation and annotation registering means for registering the added annotation and the display time information sent from the annotation adding means in the annotation managing means; and
the annotation extracting means extracts the annotation and the display time information of the annotation from the meta content managing means, retrieves the added annotation and the display time information of the added annotation from the annotation managing means, merges the annotation and the display time information extracted from the meta content managing means with the added annotation and the display time information retrieved from the annotation managing means, and distributes merged information to the terminal device.

6. The content distribution system according to claim 3, wherein, when the added annotation and the display time information of the added annotation are registered in the annotation managing means by the annotation registering means, the distributing means distributes the display information to the terminal device and distributes the annotation to the terminal device by the annotation extracting means.

7. The content distribution system according to claim 5, wherein the added annotation and the display time information of the added annotation have identification information of a content user who added the annotation; and
the displaying means allows selection between enablement and disablement of display of the added annotation in accordance with the identification information.

8. The content distribution system according to claim 1, wherein the annotation is composed of text information.

9. The content distribution system according to claim 1, wherein the annotation is composed of a graphic.
